(19) United States
(12) Patent Application Publication
(10) Pub. No.: US 2025/0207957 A1
(43) Pub. Date: Jun. 26, 2025

(54) RETRACTABLE PROBE HOUSING FOR ATTACHING TO A CONTAINER FILLED WITH MEDIUM, METHOD FOR EQUIPPING A RETRACTABLE PROBE HOUSING WITH A SENSOR AND METHOD FOR INSERTING A MEASURING PROBE INTO A MEDIUM

(71) Applicant: Exner + Tottewitz Besitz GbR, Ettlingen (DE)

(72) Inventors: Michael Tottewitz, Bruchsal (DE); Detlef EXNER, Mönsheim (DE); Gabriel CREMERS, Marxzell (DE); Timo HANSELMANN, Karlsruhe (DE)

(73) Assignee: Exner + Tottewitz Besitz GbR, Ettlingen (DE)

(21) Appl. No.: 18/978,392

(22) Filed: Dec. 12, 2024

(30) Foreign Application Priority Data
Dec. 20, 2023 (EP) 23218700.5

(51) Int. Cl. G01D 11/24; G01D 11/30

(52) U.S. Cl. CPC G01D 11/245; G01D 11/30

(57) ABSTRACT

A retractable probe housing for attaching to a container (8) filled with medium, the retractable probe housing having a fastening element (7), a measuring probe (1) and an adjusting device. The fastening element (7) is designed to be arranged on the container (8), the measuring probe (1) is designed to receive a sensor, the measuring probe (1) is arranged on the fastening element (7) so as to be movable along a movement axis, and the adjusting device is designed to interact with the fastening element (7) and the measuring probe (1) in order to move the measuring probe (1) along the movement axis. The adjusting device has an electric motor having a rotor (4) and a stator (3), and at least the rotor (4) has a recess, and the movement axis extends through the recess of the rotor.

### CROSS-REFERENCE TO RELATED APPLICATIONS

This application claims priority to European Patent Application No. 23218700.5, filed Dec. 20, 2023, which is incorporated herein by reference as if fully set forth.

### TECHNICAL FIELD

The present invention relates to a retractable probe housing for attaching to a container filled with medium. The invention furthermore relates to a method for equipping a retractable probe housing, and to a method for inserting a measuring probe into a medium.

### BACKGROUND

Retractable probe housings are commonly used to carry out measurements in an at least partially static or flowing medium that is situated in a container. Examples of a container are a closed pipeline or an entirely or partially closed process container. Retractable probe housings are of importance in particular in the process industry for the purposes of analyzing liquids. The medium in the container may be a liquid, a gas or a flowable solid (powder) or a mixture of these.

Retractable probe housings commonly comprise a measuring probe, which is designed to receive a sensor, and a fastening element. The measuring probe is arranged movably on the fastening element.

The fastening element is typically connected by means of a flange or some other process connection to the container, wherein the fastening element is arranged on the container such that the measuring probe, when in a measuring position, projects into the container. In the measuring position, an end region of the measuring probe projects beyond the fastening element, such that a measuring region of the measuring probe is in contact with the medium in the container, which measuring region may for example have a measuring window for optical measurements or a measuring opening for direct contact between a sensor and the medium.

In a rest position, the measuring region of the measuring probe is retracted and is situated within the fastening element, whereby the measuring region is sealed off with respect to the medium in the container.

With hitherto known retractable probe housings, it is thus possible for the measuring region of the measuring probe to be moved selectively between a rest position and a measuring position. The movement of the measuring probe is achieved here manually by manual movement or in automated fashion by pneumatic movement.

DE102012200438A1 has disclosed a retractable probe housing which allows the measuring probe to be moved pneumatically between the rest position and the measuring position.

One problem of conventional pneumatically operated retractable probe housings is the supply of compressed air to the retractable probe housing, which is energy-inefficient in particular owing to leaks in a supply system. Furthermore, the dependency on compressed-air sources can reduce the flexibility of the use of the retractable probe housing, in particular environments in which access to compressed air is limited.

### SUMMARY

It is therefore the object of the present invention to provide an energy-efficient and versatile retractable probe housing and a method for setting up and operating same, which make a compact construction of the retractable probe housing possible.

According to the invention, said object is achieved by means of a retractable probe housing for attaching to a container filled with medium having one or more of the features disclosed herein.

Advantageous developments of the retractable probe housing according to the invention can be found below and in the claims.

The retractable probe housing according to the invention for attaching to a container filled with medium has a fastening element, a measuring probe and an adjusting device. The fastening element is designed to be arranged on the container. The measuring probe is designed to receive a sensor. The measuring probe is arranged on the fastening element so as to be movable along a movement axis.

The adjusting device is designed to interact with the fastening element and the measuring probe in order to move the measuring probe along the movement axis.

By means of the adjusting device, it is thus possible for multiple positions to be assumed by moving the measuring probe along the movement axis, such that, in particular, a sensor arranged in the measuring probe can be moved into different positions.

It is essential that the adjusting device has an electric motor having a rotor and a stator, and that at least the rotor has a recess, and the movement axis extends through the recess of the rotor.

An advantage that arises from the use of an electric motor as part of the adjusting device is that the electric drive is energy-efficient, because it consumes energy only when a movement is required. By contrast, pneumatic systems require a continuous provision of compressed air, leading to higher energy consumption. Furthermore, the electric drive is independent of external compressed-air sources, which increases the flexibility of the use of the retractable probe housing according to the invention, in particular when it is used in complex process installations or used on containers or pipes which are situated outdoors and for which no compressed-air source is available nearby.

A further advantage consists in that the retractable probe housing according to the invention is less susceptible to particular forms of wear or leakage that can occur in pneumatic systems. This leads to increased reliability and lower maintenance costs.

The use of a rotor having a recess through which the movement axis extends yields the advantage that a compact design is achieved owing to the arrangement of the movement axis in the recess of the rotor. This allows the available space to be used efficiently, and is conducive to the retractable probe housing being usable flexibly in different environments, even in constricted spaces.

Furthermore, this arrangement offers the advantageous possibility of quickly and easily arranging a sensor in the measuring probe. This makes maintenance and exchange work much easier, which in turn reduces downtimes and improves the availability of the retractable probe housing.

The measuring probe preferably has a measuring region in order, in usage configurations in which a measuring apparatus is arranged on the container, to perform a measurement on the medium in the container. The measuring region may be in the form of a measuring window, in particular a window that is permeable to radiation, in order to perform a preferably optical measurement on the medium by means of the sensor arranged in the measuring probe. The measuring region may likewise be formed as an opening in the measuring probe, such that the sensor arranged in the measuring probe is in direct contact with the medium in the container during the measurement.

It is therefore advantageous if the measuring probe is arranged on the fastening element so as to be movable between a measuring position and a rest position such that, in the measuring position, at least the measuring region of the measuring probe projects beyond the fastening element and, in the rest position, the measuring region of the measuring probe is arranged within the fastening element, and the adjusting device is designed to interact with the fastening element and the measuring probe in order to move the measuring probe between the measuring position and the rest position.

Therefore, in usage configurations in which the retractable probe housing is arranged on the container, the measuring region, when in the measuring position and projecting beyond the fastening element, is in contact with the medium in the container such that a measurement can be performed on the medium.

The retractable probe housing is preferably designed such that, when the measuring probe is arranged in the rest position, the measuring region of the measuring probe is fluid-tightly sealed off with respect to the medium in the container. This yields the advantage that, in the rest position, the sensor is not impinged on by the medium and can be rinsed, calibrated and/or exchanged without medium from the container infiltrating into the measuring probe or the retractable probe housing.

The retractable probe housing is advantageously designed such that, at least in one of the positions of measuring position and rest position, preferably at least in the rest position, the measuring probe is arranged in the recess of the rotor. This allows a compact and stable design of the retractable probe housing. In particular, it is advantageous if the measuring probe is guided in the recess of the rotor over the entire movement travel between measuring position and rest position.

It is furthermore advantageous that the position of the measuring probe in the recess of the rotor is conducive to protecting the measuring probe against external influences, in particular against possible mechanical influences.

Advantageously, the electric motor of the retractable probe housing is designed as a hollow-shaft motor, and the movement axis extends within the hollow shaft of the hollow-shaft motor. In particular, the measuring probe is preferably arranged movably in the hollow shaft of the hollow-shaft motor, wherein the movement axis of the measuring probe is preferably arranged parallel to a longitudinal axis of the hollow shaft of the hollow-shaft motor.

The electric motor of the adjusting device is preferably designed such that the rotor is arranged within the stator. This yields a compact construction, because the stator can be connected to an outer casing of the retractable probe housing.

For a compact construction, it is therefore advantageous if the movement axis of the measuring probe is arranged parallel to an axis of rotation of the rotor.

It falls within the scope of the invention for the electric motor of the adjusting device to be designed as a brushless DC motor and/or as a stepper motor.

A preferred embodiment of the electric motor as a brushless DC motor yields the advantage that such a motor requires little maintenance. It additionally has a longer service life owing to the reduced wear.

A preferred embodiment of the electric motor as a stepper motor yields the advantage that the stepper motor requires little maintenance, because it requires no brushes or commutators. Furthermore, exact positioning of the measuring probe is possible by means of a stepper motor.

It is particularly advantageous for the electric motor of the adjusting device to be designed as a reluctance motor, in particular as a switched reluctance motor or a synchronous reluctance motor.

It is advantageous here that the losses occur primarily in the static stator, and the heat losses that arise can thus be easily dissipated to the outside. Heating of the rotor therefore scarcely occurs, such that the sensor probe is subjected only little to the heat of the losses that arise.

A further advantage of the design of the electric motor as a reluctance motor consists in that reluctance motors do not require rare earths for the production of permanent magnets. This reduces the dependency on limited and environmentally harmful resources involved in the mining and processing of rare earths. The reluctance motor is therefore advantageously free from rare earths.

It falls within the scope of the invention for the rotational movement of the rotor of the electric motor to be transmitted by means of toothed gears or rollers, in particular plastics rollers, to the measuring probe in order to realize the movement. In particular, it falls within the scope of the invention for the measuring probe to have at least one toothed rack, and for the adjusting device to be designed to transmit the rotational movement of the electric motor by means of at least one toothed gear of the adjusting device to the toothed rack in order to generate a linear movement.

In one advantageous embodiment, the rotor is operatively connected directly, in particular without an interposed mechanism, to the measuring probe in order to effect the movement of the measuring probe. This yields the advantage of a saving of mechanical components in relation to the use of a mechanism.

In one advantageous development, the rotor is preferably operatively connected indirectly via a mechanism device of the retractable probe housing to the measuring probe in order to effect the movement of the measuring probe. The adjusting device therefore advantageously has a mechanism device, the drive of which is operatively connected to the electric motor, and the output of which is operatively connected to the measuring probe. This makes it possible for a higher force to be exerted on the measuring probe by means of the electric motor in relation to an embodiment without a mechanism. In particular, it is hereby possible to use compact electric motors, the torque of which would not allow a required force to be exerted on the measuring probe without the use of a mechanism. The mechanism device may have one or more mechanisms.

The mechanism device preferably has a mechanical mechanism, in particular a positively locking mechanism.

It falls within the scope of the invention for the mechanism device to have one or more mechanisms, preferably exactly one mechanism, from the following list:
planetary gear mechanism,
strain wave gear mechanism,
cycloidal gear mechanism,
toothed gear mechanism,
toothed belt mechanism,
chain mechanism,
plate-link chain mechanism between bevel-wheel-like wheels,
belt mechanism,
bevel ring mechanism,
rolling element mechanism, and
rolling ring mechanism.

In particular, it is advantageous if the mechanism device has a cycloidal gear mechanism in order to achieve a compact structural form and owing to the advantages mentioned below.

The mechanism device preferably has a screw mechanism, preferably having a spindle drive and a threaded spindle, in order to convert a rotational movement of the electric motor into a linear movement of the measuring probe. A compact structural form is thus achieved. In particular, it is advantageous for the measuring probe to be formed as part of the screw mechanism, in particular as a threaded spindle.

In one advantageous embodiment, the output of the electric motor is connected to the screw mechanism without the interposition of a further mechanism. In an alternative advantageous development, in addition to the screw mechanism, the mechanism device has at least one further, preferably exactly one further, mechanism, in particular a mechanism from the above list of mechanisms, preferably a cycloidal gear mechanism.

In a further preferred embodiment, the spindle drive of the mechanism device has a threaded spindle and a spindle nut, wherein the spindle nut is arranged rotatably on the threaded spindle, and wherein the electric motor is operatively connected to the spindle nut in order to rotate the spindle nut. In particular, it is advantageous here for the measuring probe to be designed as a threaded spindle. An advantage here is the compact design, which is preferably achieved by virtue of the measuring probe being formed as a spindle drive, in particular as a threaded rod.

In a further preferred embodiment, the mechanism device has a ball screw drive. An advantage here is the reduced friction owing to the balls. In particular, for a compact structural form, it is advantageous for the measuring probe to be designed as a ball spindle or recirculating ball spindle.

A further advantage of the use of the measuring probe designed as a threaded spindle as part of the spindle drive consists in that a precise linear movement of the measuring probe with low friction is made possible.

In a further preferred embodiment, the measuring probe formed as a threaded spindle is of multi-part form. An advantage here is the reduced manufacturing complexity.

In a preferred embodiment, the adjusting device has a mechanism device having a cycloidal gear mechanism and a spindle drive, wherein the cycloidal gear mechanism is designed to transmit to the spindle drive the torque which is imparted by the electric motor. An advantage here is the compact design of cycloidal gear mechanisms, which allow efficient use of the available structural space in the retractable probe housing. In particular, for a compact structural form, it is advantageous here for the measuring probe to be designed as a threaded spindle.

It is furthermore advantageous that, by using cycloidal gear mechanisms, expenditure on maintenance can be reduced, because cycloidal gear mechanisms have low susceptibility to wear owing to their design.

There is also the resulting advantage that a high transmission ratio is realized in a small structural space, because cycloidal gear mechanisms allow a high transmission ratio in a small structural space owing to their design.

A compact design of the adjusting device is made possible by the combination of cycloidal gear mechanism and spindle drive. This is particularly advantageous in order to efficiently utilize the available structural space. Furthermore, the spindle drive has a self-locking characteristic, which ensures that the measuring probe remains stably in the current position and is not undesirably moved.

In a further preferred embodiment, the cycloidal gear mechanism of the mechanism device has a recess, and the movement direction of the measuring probe extends through said recess of the cycloidal gear mechanism. In particular, the measuring probe is preferably arranged in the recess of the cycloidal gear mechanism at least in the rest position and/or in the measuring position. The measuring probe is preferably guided in the recess of the cycloidal gear mechanism over the movement travel between the rest position and the measuring position. This results in a compact and robust construction.

In a further preferred embodiment, the cycloidal gear mechanism of the mechanism device is arranged between the electric motor and that side of the fastening element which is designed to be arranged on the container. An advantage of this arrangement consists in that it offers better accessibility for maintenance and repair work. Access to the drive components is made easier owing to the fact that the cycloidal gear mechanism is accommodated underneath the electric motor. In particular, electrical power can be supplied to the electric motor via that side of the retractable probe housing which faces away from the container, without the electrical lines having to be led past the cycloidal gear mechanism or through the mechanism.

In a preferred embodiment, the cycloidal gear mechanism is designed as a cycloidal eccentric gear mechanism, preferably as a multiply cycloidal eccentric gear mechanism, particularly preferably as a doubly cycloidal eccentric gear mechanism. In a multiply cycloidal gear mechanism, a plurality of cycloidal disks are used which are arranged offset with respect to one another. In the case of the doubly cycloidal eccentric gear mechanism, two cycloidal disks which are offset by 180° are used. An advantage here is that the imbalances caused by the eccentric are compensated. This leads to smoother running and reduces the load on the components.

In a preferred embodiment, the cycloidal gear mechanism has a transmission ratio i (drive: output) of i=5:1 to i=100:1, preferably i=8:1 to i=15:1.

In a further preferred embodiment, the mechanism device has a belt and belt pulleys, wherein at least one of the belt pulleys is connected to the electric motor, and the measuring probe is movable by means of the belt. This allows the rotational movement to be efficiently and inexpensively converted into a linear movement.

In a preferred embodiment, the adjusting device has a mechanism device having a planetary gear mechanism or a strain wave gear mechanism, wherein the planetary gear mechanism or the strain wave gear mechanism is designed to transmit to the spindle drive the torque which is imparted by the electric motor. An advantage here is that, by using planetary gear mechanisms and strain wave gear mechanisms, expenditure on maintenance can be reduced, because planetary gear mechanisms and strain wave gear mechanisms have low susceptibility to wear owing to their design.

In a further preferred embodiment, the mechanism device has a recirculating ball spindle having a spindle with ball bearings, by means of which the measuring probe is movable. Advantages here are the movement of the components with low friction and the exact positioning of the measuring probe, which improve the durability and precision of the retractable probe housing.

In a further preferred embodiment, the mechanism device has a toothed rack having a toothed gear, wherein the toothed gear is connected to the cycloidal gear mechanism, and wherein the measuring probe is formed at least in part as a toothed rack. An advantage here is that, by using the toothed rack and the toothed gear, a robust, efficient and compact arrangement of the components is possible.

In a further preferred embodiment, the adjusting device has a bevel gear mechanism, wherein the crown gear of the bevel gear mechanism is connected to the rotor of the electric motor, and the pinion of the bevel gear mechanism is connected to a toothed gear, and wherein the measuring probe is formed at least in part as a toothed rack. Here, the toothed gear engages into the toothed rack of the measuring probe, such that a rotational movement of the toothed gear causes the measuring probe to be moved linearly. An advantage here is that, by using a toothed rack and toothed gear, a robust and compact arrangement of the components is possible. The bevel gear mechanism furthermore allows easy transmission of a rotational speed.

In a further preferred embodiment, the adjusting device has a manual actuation mechanism, wherein this is designed to move the measuring probe between the measuring position and the rest position as a result of a manual actuation.

The manual actuation mechanism makes it possible to implement manual emergency operation; here, the retractable probe housing is in a deenergized state and the electrical components are thus decoupled. For this purpose, the manual actuation mechanism has a manual actuation element, preferably a lever or a wheel. Said manual actuation element is accessible to the user and makes it possible, for example by way of a rotational movement, to move the measuring probe between the measuring position and the rest position. The manual actuation element can preferably be arranged releasably on the retractable probe housing. In one advantageous embodiment, the rotational movement of the manual actuation element causes the rotor to be rotated.

In one advantageous embodiment of the retractable probe housing having a manual actuation mechanism, the adjusting device has a locking mechanism that releases the manual actuation mechanism for the purposes of manual actuation. Inadvertent use of the manual mechanism can thus be prevented. Manual actuation in the energized state can also be prevented. It is advantageous that maintenance and inspection work can be made easier by the locking mechanism.

In one advantageous embodiment, the retractable probe housing has at least one intermediate position between the measuring position and the rest position, wherein the adjusting device is designed to move the measuring probe selectively into the measuring position, intermediate position and rest position. This allows the retractable probe housing to be flexibly adapted in accordance with the specific requirements and usage scenarios, whereby precise positioning of the measuring probe in different positions is achieved.

In one advantageous embodiment, the retractable probe housing comprises an additional shielding element which serves for shielding against undesired electromagnetic interference and for improving the electromagnetic compatibility of the retractable probe housing. Here, the shielding element is formed from electrically conductive material. This measure is conducive to improving the reliability of the retractable probe housing, and its immunity to interference, in different usage environments; in particular, this measure is conducive to preventing interference with electronic components, in particular measurement equipment.

In one advantageous embodiment, the retractable probe housing comprises an additional brake element that serves to prevent the measuring probe from moving when the latter is situated in the measuring position, the rest position or an intermediate position. The brake element is preferably designed as a simple detent, particularly preferably as a conical brake. An advantage here is that the measuring probe is prevented from moving when the electric motor is deenergized. This is advantageous in particular if the medium in the container is pressurized, because this can cause undesired movement of the measuring probe.

In a further advantageous embodiment, the measuring probe is arranged centrally in the recess of the cycloidal gear mechanism and centrally in the recess of the rotor, such that the cycloidal gear mechanism and the rotor are arranged concentrically around the measuring probe. An advantage here is that a symmetrical orientation is achieved, leading to improved stability. A further advantage consists in that a more compact design is made possible owing to the concentric arrangement.

In a further advantageous embodiment, the retractable probe housing has a cleaning device having a fluid-tight rinsing chamber and having a rinsing medium supply. The rinsing chamber has a recess through which the measuring probe is arranged at least in the measuring position, and in which the measuring probe is arranged, at least with the measuring region of the measuring probe, in an intermediate position. An advantage here is that deposits or contaminants that accumulate in the measuring region of the measuring probe as a result of the contact with the medium in the container can be cleaned in the rinsing chamber by means of a rinsing medium. This leads to an improvement in measuring accuracy, and the reliability of the measurement of the medium is thus increased.

In a further advantageous embodiment, the retractable probe housing has a position-detecting means; the position-detecting means preferably has Hall sensors in order to detect when positions such as the rest position, the measuring position or an intermediate position are reached. An advantage here is that the position-detecting means provides information regarding the position of the measuring probe. Furthermore, owing to the use of Hall sensors, contactless detection is made possible, which reduces expenditure on maintenance.

In a further advantageous embodiment, the retractable probe housing has an anti-movement safeguard in order to prevent the measuring probe, when it does not have a sensor inserted therein, from moving into the container. An advantage here is that the anti-movement safeguard creates an additional safety level for preventing undesired movements of the measuring probe.

The fastening element may be of a design known per se. In particular, it falls within the scope of the invention for the fastening element to be of multi-part form, in particular having a connection element for the connection and fastening of the retractable probe housing to the container, in particular to a flange of the container, and having a receptacle for the measuring probe, wherein the measuring probe is arranged movably in the receptacle.

It falls within the scope of the invention for the fastening element to be designed such that the fastening element, in particular a receptacle of the fastening element, extends into the interior of the container when the retractable probe housing is attached to the container. In particular, it falls within the scope of the invention for the measuring region of the measuring probe to be arranged in the interior of the container even in the rest position, wherein, in this advantageous development, the measuring region is arranged in the fastening element in the rest position, and therefore, despite the fact that the measuring region is situated in the interior of the container even in the rest position, the shielding by the fastening element means that there is no contact between the medium and the measuring region of the measuring probe.

The aforementioned object is achieved by means of a method according to the invention for equipping a retractable probe housing with a sensor having one or more of the features disclosed herein. The method has the following method steps:
providing a retractable probe housing having a fastening element for attaching to a container, having a measuring probe for receiving a sensor, and having an adjusting device,
wherein the adjusting device has an electric motor having a rotor and a stator, and the rotor has a recess;
in particular, providing a retractable probe housing according to the invention, preferably a preferred embodiment thereof; and
inserting the sensor into the measuring probe, wherein the sensor is passed through the recess of the rotor.

An advantage here is the precise sensor placement, because the insertion through the recess in the rotor ensures exact positioning. A further advantage is that the method allows the use of a compact retractable probe housing. The method is furthermore advantageous because contamination of the sensor is thus avoided, because the fact that the sensor is guided through the recess in the rotor means that the risk of contamination is reduced. A further advantage is that a consistent sensor orientation is thus achieved, because the recess in the rotor ensures an invariant orientation of the sensor.

In one advantageous embodiment, the retractable probe housing is designed as a retractable probe housing according to the invention, in particular a preferred embodiment thereof.

The object mentioned in the introduction is furthermore achieved by means of a method according to the invention for inserting a measuring region of a measuring probe into a medium having one or more of the features disclosed herein, which has the following method steps:
providing a retractable probe housing having a fastening element for attaching to a container, having a measuring probe for receiving a sensor, and having an adjusting device;
wherein the adjusting device has an electric motor having a rotor and a stator, and the rotor has a recess, and the measuring probe has a measuring region arranged preferably at an end,
and wherein, during the insertion process, the measuring probe is moved within the recess of the rotor. Such a fastening element is described in DE102012200438A1.

An advantage here is the targeted movement along a rectilinear movement axis of the measuring probe within the recess of the rotor, because this leads to exact positioning in the medium. A further advantage is the minimization of contamination, because the targeted movement within the recess reduces the risk of contamination and protects the measuring probe against external influences. A further advantage is that this method allows a compact construction of the retractable probe housing.

In one advantageous embodiment, the retractable probe housing is designed as a retractable probe housing according to the invention, in particular an advantageous embodiment thereof.

### BRIEF DESCRIPTION OF THE DRAWINGS

Further features and advantages of the present invention will become apparent from the following drawings and exemplary embodiments, on the basis of which the invention will be discussed in more detail by way of example, without the invention being restricted to these. In the drawings:

FIG. 1 is a schematic illustration of a first exemplary embodiment of a retractable probe housing according to the invention in a rest position;

FIG. 2 is a schematic illustration of the first exemplary embodiment of a retractable probe housing according to the invention in a measurement position;

FIG. 3 is a schematic illustration of a second exemplary embodiment of a retractable probe housing according to the invention in a rest position; and

FIG. 4 is a schematic illustration of a third exemplary embodiment of a retractable probe housing according to the invention in a rest position.

### DETAILED DESCRIPTION

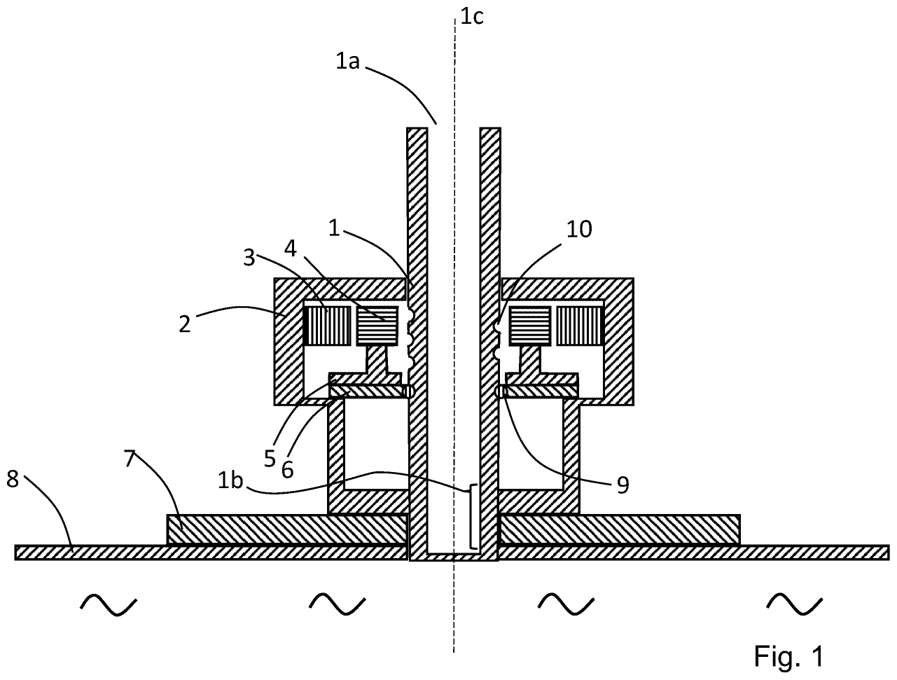

In FIGS. 1, 2, 3 and 4, the same reference designations are used to denote identical elements or elements of identical function.

FIG. 1 is a schematic illustration of a first exemplary embodiment of a retractable probe housing according to the invention. The retractable probe housing has a fastening element 7, which is arranged on a container 8 which is filled with medium. The retractable probe housing has an adjusting device having an electric motor, wherein the electric motor has a rotor 4 and a stator 3. The measuring probe 1 has a cavity 1a into which a sensor can be inserted; this sensor is not illustrated in the figure. The measuring probe 1 is arranged on the fastening element 7 so as to be linearly movable along the movement axis 1c.

The fastening element 7 has a flange-like base that has a recess. The fastening element 7 furthermore has a casing 2 of the retractable probe housing. In this case, the casing 2 has a rotationally symmetrical form with an upper and a lower recess. The casing 2 adjoins a cavity in which the adjusting unit with its electric motor, which in this exemplary embodiment is designed as a switched reluctance motor, is arranged. Coils are wound around the stator teeth of the stator 3, and the rotor 4 has a central recess, wherein the recess of the rotor 4 and the upper and the lower recess of the casing 2 are oriented coaxially. The stator 3 is connected to the casing 2, and the rotor 4 is mounted so as to be rotatable.

The measuring probe 1 of the retractable probe housing is arranged centrally through the recess of the rotor 4, and through the upper and the lower recess of the casing 2. In the exemplary embodiment shown, the measuring probe 1 is situated in the rest position. In the rest position, the measuring probe 1 is not inserted into the container 8.

The measuring probe 1 has a measuring region 1b, designed in the present case as a glass window. Contact-free optical measurement of the medium is thus possible through the glass window by means of the sensor arranged in the measuring probe 1. In an alternative embodiment, the measuring region 1b is formed as an opening in the measuring probe, allowing direct contact between the sensor and the medium.

In the illustration in FIG. 1, the measuring probe is situated in the rest position, such that the measuring region is situated in the fastening element and there is therefore no contact between the measuring region and the medium.

In this exemplary embodiment, the adjusting device has a mechanism device having a cycloidal gear mechanism and a spindle drive, wherein the cycloidal gear mechanism is designed to transmit to the spindle drive the torque which is imparted by the electric motor.

The measuring probe 1 has an external thread and thus forms the threaded spindle 10 of the spindle drive. The spindle drive furthermore has a spindle nut 9.

In this embodiment, the cycloidal gear mechanism has a hollow eccentric shaft 5 that surrounds the measuring probe 1. Also provided is a roller disk 6 which has a recess and which thus surrounds the measuring probe 1. The roller disk 6 has rollers arranged vertically with respect to the extent of the roller disk. The cycloidal gear mechanism furthermore has a cam disk and static roller pins that are arranged annularly around the eccentric shaft 5. The eccentric shaft 5 is connected to the rotor 4. The roller disk 6 is connected via a central output shaft to the spindle nut 9 of the spindle drive. The cam disk is arranged around the eccentric shaft 5.

If the rotor 4 drives the eccentric shaft 5, the cam disk is moved eccentrically, such that the cam disk rotates about its axis of symmetry. Holes are formed in the cam disk, which holes rotate relative to the eccentric shaft 5. The rollers of the roller disk 6 engage into said holes. The cam disk thus drives the roller disk 6, on which the centrally mounted output shaft is also arranged and seated coaxially with respect to the drive shaft.

The spindle nut 9 connected to the drive shaft is arranged so as to engage into the threaded spindle 10 of the measuring probe 1, such that the rotational movement of the spindle nut 9 leads to a translational movement of the measuring probe 1. The rotational movement of the spindle nut 9 is thus converted by means of the threaded spindle 10 into a linear movement of the measuring probe 1.

The transmission ratio of the cycloidal gear mechanism is in this case i (drive:output)=10:1.

In order to determine the position of the rotor 4, the retractable probe housing has a rotary encoder. In this exemplary embodiment, the rotary encoder is formed with Hall sensors. In an alternative exemplary embodiment, the rotary encoder has optical sensors for position determination purposes.

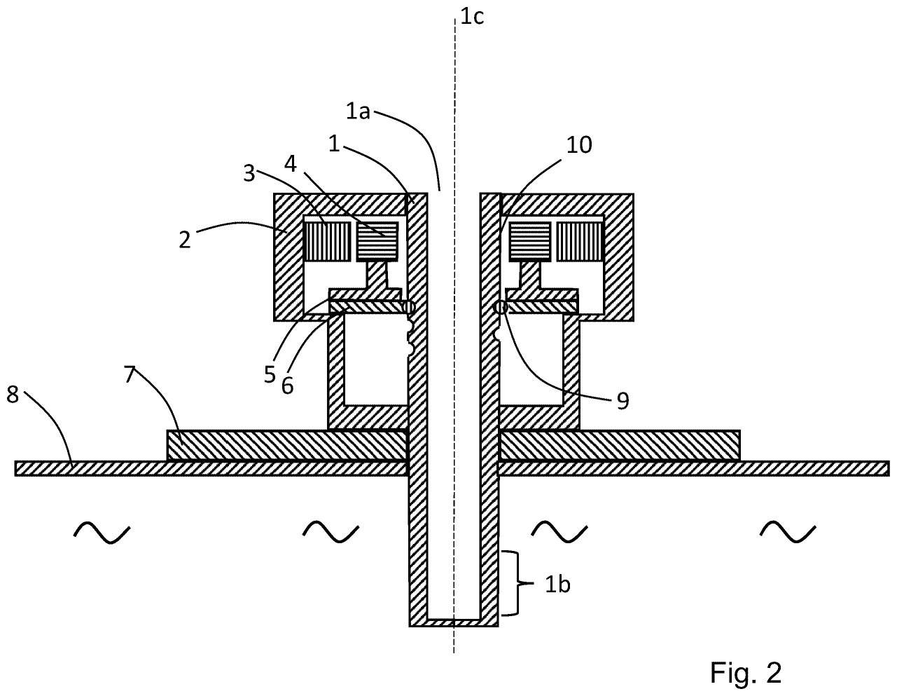

FIG. 2 shows the measuring probe in its measuring position, in which the measuring probe 1 projects into the container 8 filled with medium. In particular, the measuring region 1b is in contact with the medium in order to allow a measurement.

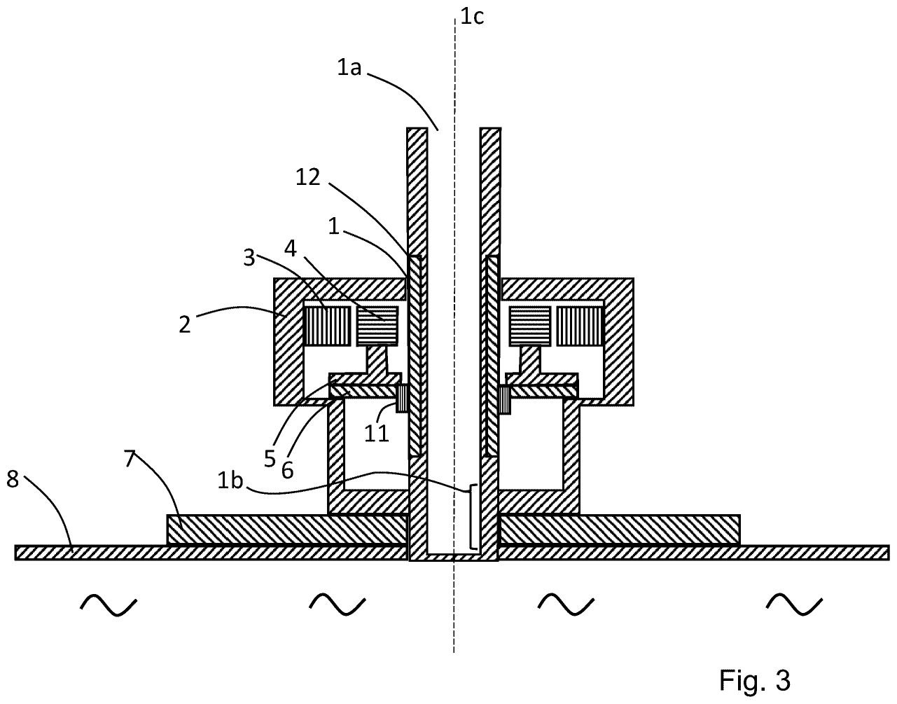

FIG. 3 shows a second exemplary embodiment of a retractable probe housing according to the invention, which differs from the exemplary embodiment in FIGS. 1 and 2 in that the mechanism device has not a spindle drive but a measuring probe 1 designed as a toothed rack 12, and the cycloidal gear mechanism is connected via a crown gear and a pinion to a toothed gear 11 that engages into the toothed rack 12. The rotational movement of the crown gear is thus converted by means of the pinion and the toothed gear 11 connected thereto into a linear movement of the measuring probe 1 designed as a toothed rack 2.

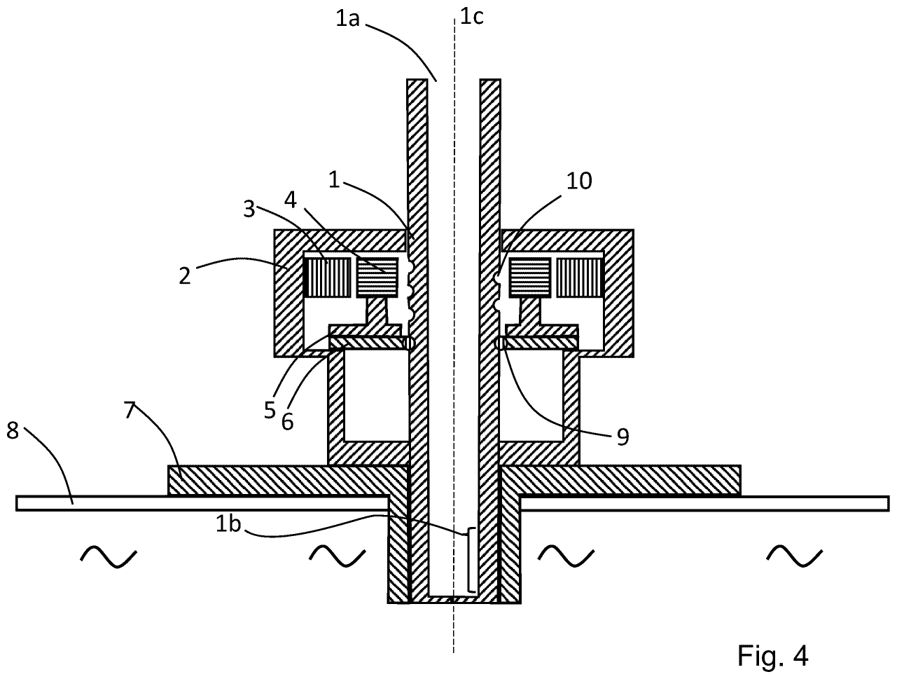

FIG. 4 shows a modification of the exemplary embodiment illustrated in FIG. 1. To avoid repetitions, only the main differences will be discussed below: In the exemplary embodiment shown in FIG. 4, the fastening element 7 is designed so as to project into the container 8. In the illustration in FIG. 4, the measuring probe 1 is situated in the rest position. Even in the rest position, the lower end of the measuring probe, and in particular the measuring region 1b, is situated in the interior of the container 8. The measuring region is however additionally situated in the interior of the fastening element 7 and is thus shielded with respect to the medium, such that, in the rest position, there is no contact between the medium and measuring regions 1b.

In the measuring position, which is not illustrated, the measuring probe has been moved downward, analogously to the illustration in FIG. 2, such that the lower end of the measuring probe 1 projects beyond the fastening element 7, and the measuring region 1b is in direct contact with the medium.

### LIST OF REFERENCE SIGNS

1 Measuring probe
1a Cavity of the measuring probe
1b Measuring region of the measuring probe
1c Movement axis of the measuring probe
2 Casing
3 Stator of the electric motor
4 Rotor of the electric motor
5 Eccentric shaft of the cycloidal gear mechanism
6 Roller disk with output shaft
7 Fastening element
8 Container
9 Spindle nut
10 Threaded spindle
11 Toothed gear
12 Toothed rack

1. A retractable probe housing for attaching to a container (8) filled with medium,
the retractable probe housing comprising:
a fastening element (7), a measuring probe (1) and an adjusting device;
wherein the fastening element (7) is adapted to be arranged on the container (8), the measuring probe (1) is adapted to receive a sensor, and the measuring probe (1) is arranged on the fastening element (7) so as to be movable along a movement axis (1c); and the adjusting device is designed to interact with the fastening element (7) and the measuring probe (1) in order to move the measuring probe (1) along the movement axis (1c); and
the adjusting device includes an electric motor having a rotor (4) and a stator (3), and
at least the rotor (4) has a recess, and the movement axis (1c) extends through the recess of the rotor.

2. The retractable probe housing as claimed in claim 1, wherein the measuring probe (1) is arranged on the fastening element (7) so as to be movable between a measuring position and a rest position such that, in the measuring position, at least a measuring region (1b) of the measuring probe (1) projects beyond the fastening element (7) and, in the rest position, the measuring region (1b) of the measuring probe (1) is arranged within the fastening element (7), and the adjusting device is designed to interact with the fastening element (7) and the measuring probe (1) in order to move the measuring probe (1) between the measuring position and the rest position.

3. The retractable probe housing as claimed in claim 1, wherein the retractable probe housing is designed such that, when the measuring probe (1) is arranged in the rest position, the measuring region (1b) of the measuring probe is fluid-tightly sealed off with respect to the medium in the container.

4. The retractable probe housing as claimed in claim 1, wherein the movement axis (1c) of the measuring probe is arranged parallel to an axis of rotation of the rotor.

5. The retractable probe housing as claimed in claim 1, wherein the electric motor of the adjusting device is a reluctance motor.

6. The retractable probe housing as claimed in claim 5, wherein the electric motor is a switched reluctance motor or a synchronous reluctance motor.

7. The retractable probe housing as claimed in claim 1, wherein the adjusting device comprises a mechanism device, including a cycloidal gear mechanism and a spindle drive, and the cycloidal gear mechanism is adapted to transmit torque imparted by the electric motor to the spindle drive.

8. The retractable probe housing as claimed in claim 7, wherein the cycloidal gear mechanism has a recess, and the movement axis (1c) of the measuring probe (1) extends through said recess.

9. The retractable probe housing as claimed in claim 7, wherein the cycloidal gear mechanism comprises a cycloidal eccentric gear mechanism.

10. The retractable probe housing as claimed in claim 9, wherein the cycloidal gear mechanism comprises a multiply cycloidal eccentric gear mechanism.

11. The retractable probe housing as claimed in claim 7, wherein the cycloidal gear mechanism has a transmission ratio of i=5:1 to i=100:1.

12. The retractable probe housing as claimed in claim 11, wherein the cycloidal gear mechanism transmission ratio of i=8:1 to i=15:1.

13. The retractable probe housing as claimed in claim 7, wherein the spindle drive of the mechanism device has a threaded spindle (10) and a spindle nut (9), the spindle nut (9) is arranged rotatably on the threaded spindle (10), and the spindle nut (9) is connected to the cycloidal gear mechanism.

14. The retractable probe housing as claimed in claim 13, wherein the measuring probe (1) is formed as the threaded spindle (10).

15. A method for equipping a retractable probe housing with a sensor,
the method comprising the steps of:
providing a retractable probe housing having a fastening element (7) for attaching to a container (8), the retractable probe housing having a measuring probe (1) for receiving a sensor, and having an adjusting device,
wherein the adjusting device has an electric motor having a rotor (4) and a stator (3), and the rotor (4) has a recess; and
inserting the sensor into the measuring probe (1) by passing the sensor through the recess of the rotor (4).

16. A method for inserting a measuring region of a measuring probe (1) into a medium, the method comprising the steps of:
providing a retractable probe housing having a fastening element (7) for attaching to a container (8), the retractable probe housing having a measuring probe (1) for receiving a sensor, and having an adjusting device;
wherein the adjusting device has an electric motor having a rotor (4) and a stator (3), and the rotor (4) has a recess, and the measuring probe has a measuring region (1b) arranged preferably at an end; and
during the insertion process, moving the measuring probe (1) within the recess of the rotor (4) by the movement device.
